(19) United States
(12) Patent Application Publication
(10) Pub. No.: US 2005/0289257 A1
(43) Pub. Date: Dec. 29, 2005

(54) Self-powered USB device with USB power line reset and related USB host and USB system

(76) Inventor: Thomas M. Fink, Tipp City, OH (US)

Correspondence Address: THOMPSON HINE LLP, 2000 COURTHOUSE PLAZA N.E., 10 WEST SECOND STREET, DAYTON, OH, 45402-1758, US

(21) Appl. No.: 10/876,047

(22) Filed: Jun. 24, 2004

(51) Int. Cl. G06F 13/12

(52) U.S. Cl. 710/62

(57) ABSTRACT

Self-powered USB peripheral/slave devices can be reset using a hardware reset circuit associated with the USB power line of the device, even in circumstances where the controller of the self-powered USB device is unable to properly communicate with a USB host.

### TECHNICAL FIELD

The present application relates generally to devices that utilize USB communications, and more particularly to a self-powered USB device that includes a reset capability triggerable via the USB power line.

### BACKGROUND

Many computers and related devices used today utilize Universal Serial Bus (USB) communication ports and protocols for communicating with other devices. One device typically acts as a USB host, and communicates with one or more peripheral devices that act as USB slaves. The USB standard includes a power line on which 5 Volt bus power is supplied by the USB host. Certain USB slave devices utilize the 5 Volt bus for operating power. Other USB slave devices, known as self-powered USB devices, include their own on-board power supply and therefore do not make use of the 5 Volt bus for operating power. In the real world operating environment, from time to time self-powered USB slave devices will have processing failures and must be restarted (effectively rebooted) in order to facilitate continued operation. It would be desirable to provide an effective and convenient technique for restarting such self-powered USB slave devices.

### SUMMARY

In one aspect, an electronic device includes an electronic controller and a USB interface port associated with the electronic controller for enabling communication with an external device. A power source, independent of a power line of the USB interface port, powers the electronic controller. A hardware reset circuit is operatively connected with the power line of the USB interface port and is connected to provide a reset input signal to the electronic controller when a reset characteristic of a signal on the power line of the USB interface port occurs.

In another aspect, a method is provided in connection with an electronic device including an electronic controller with a reset function, a USB interface port for communications and a power source independent of a power line of the USB interface port. The method of resetting involves: via a hardware circuit internal to the electronic device, monitoring power associated with the USB interface port power line; and upon detection of a threshold change in a signal associated with the USB interface power line, the hardware circuit outputs a reset signal to the electronic controller even when power supplied by the power source is normal.

In a further aspect, in a computerized machine operating in communication with a self-powered USB slave device, the machine acting as a USB host and connected for communication with the self-powered USB slave device via a USB connection, a method of resetting the USB slave device involves the machine operating to temporarily establish a reset characteristic on a power line of the USB connection.

In still another aspect, a computerized machine is operable as a USB host for communication with a self-powered USB electronic device. The machine includes a USB communication monitor for detecting a self-powered USB electronic device processing failure state. A reset control associated with the USB communication monitor responds to detection of a self-powered USB electronic device processing failure state by temporarily establishing a reset characteristic on a USB power line.

In a further aspect, an electronic device includes an electronic controller and a USB interface port associated with the electronic controller for enabling communication with external devices. A power source, independent of a power line of the USB interface port, powers the electronic controller. A hardware reset circuit is operatively connected to provide a reset input signal to the electronic controller, the hardware reset circuit operatively connected to be triggered via the power line of the USB interface port.

### BRIEF DESCRIPTION OF THE DRAWINGS

FIG. 1 is a block diagram of a USB host device connected with a self-powered USB slave/peripheral device that includes a hardware reset circuit associated with a USB power line;

FIG. 2 is a schematic of one embodiment of a hardware reset circuit; and

FIG. 3 is a schematic of another embodiment of a hardware reset circuit.

### DETAILED DESCRIPTION

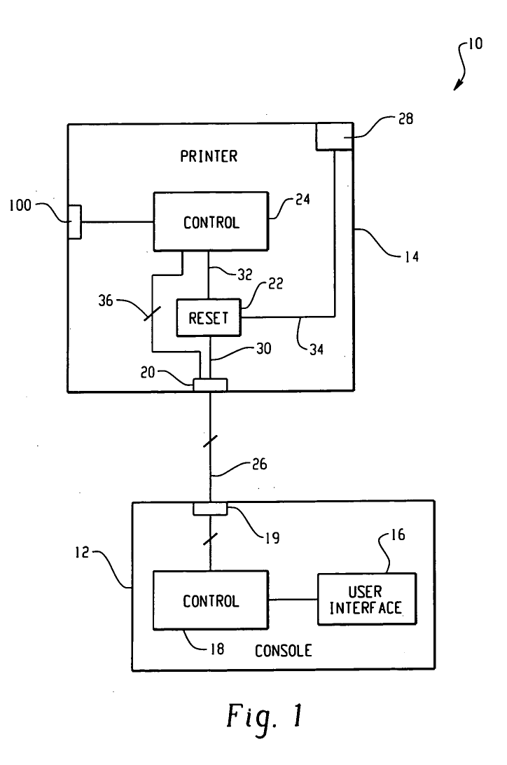

Referring to FIG. 1, an exemplary USB system includes a user console 12 acting as a USB host and a self-powered printer 14 acting as a USB slave. The console 12 includes a user interface 16, an associated control 18 (such as an electronic controller with one or more microprocessors or microcontrollers and related circuitry) and at least one USB connector or port 19. The printer 14 includes at least one USB port 20, a hardware reset circuit 22 connected with the USB power line of the port 20, and a control 24 for carrying out printer operations and communicating with the control 18 of the console. USB communication lines 26 connects port 19 and 20. Independent power source 28 of the printer 14 is also shown and provides operating power for the control 24 and the printer as a whole. In one example the power source 28 might take the form of an AC/DC converter that connects to receive AC power from a standard power outlet. The hardware reset circuit 22 operates to cause the control 24 of printer 14 to reset when the control 18 of console 12 causes a reset characteristic to appear on the power line or power terminal of the printer's USB interface port 20.

In the illustrated embodiment, a line 30 connects the USB port power terminal to the hardware reset circuit 22, which in turn is connected by line 32 to provide a reset input to the control 24. A power input from the on-board power supply 28 is also connected with the hardware reset circuit 22 as shown by line 34. The data terminals of USB interface port 20 are connected to the control 24 as reflected by lines 36.

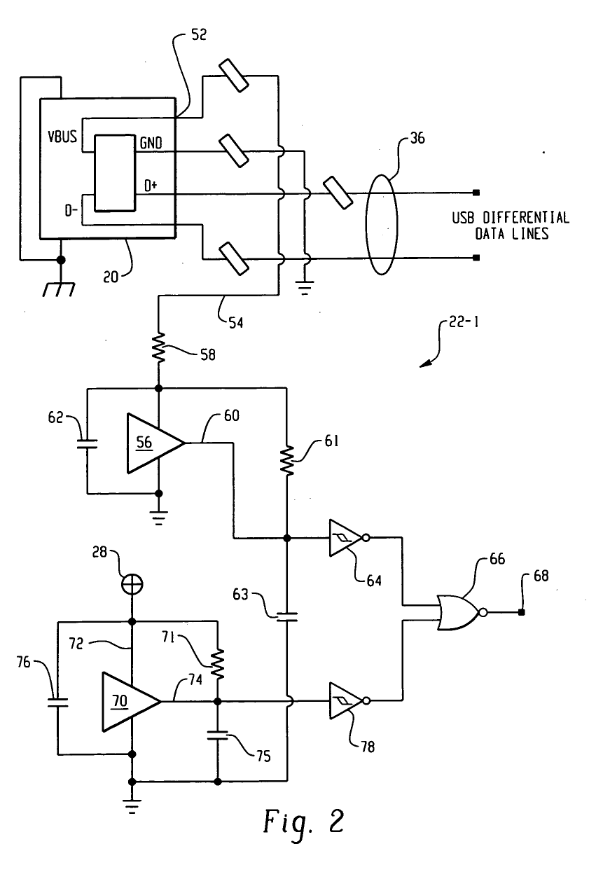

One exemplary embodiment of a hardware reset circuit 22 is shown in FIG. 2 as circuit 22-1. The connector defining the USB port is shown at 20, with USB differential data lines 36 also shown. The power terminal 52 of the port 20, which connects to the USB source power, is connected with line 54 which leads to the reset circuit 22-1. In particular, line 54 connects with a voltage responsive component 56 through a resistor 58. The component 56 includes an output 60. Resistor 61 is connected between the component input and output 60, and capacitor 63 is connected between the component output 60 and ground. When the input to component 56 on line 54 is high, meaning standard 5 Volt bus power is being applied to the USB power terminal, the output 60 of component 56 remains high as a result of the voltage that is established across capacitor 63 through resistor 61. When the input drops below a threshold voltage, such as about 4.5 Volts, the output 60 is set low when the component 56 connects the output 60 to ground. In one example, component 56 is a DS 1811 EconoReset IC available from Dallas Semiconductor. A bypass capacitor 62 connected between the component input and ground provides stabilization in the event of momentary fluctuations of the voltage on the line 54. The output 60 of component 56 is connected to the input of NOT gate 64, and the output of NOT gate 64 is connected as one input to an NOR gate 66. The output 68 of NOR gate 66 connects with line 32 (FIG. 1).

The hardware reset circuit 22-1 also includes a voltage sensitive component 70 having an input line 72 connected to the on-board power supply 28 of the printer, a resistor 71 connecting the input 72 to output 74, and a capacitor 75 connecting the output 74 to ground. Similar to component 56, when the input to component 70 on line 72 is high, meaning power is being supplied by the power supply 28 at a set voltage such as 5 Volts, the output 74 of component 70 remains high, but when the input drops below a threshold voltage, such as about 4.5 Volts, the output 74 is set low. Bypass capacitor 76 is also provided. The output 74 of component 70 is connected to the input of NOT gate 78, and the output of NOT gate 78 is connected as another input to NOR gate 66.

In operation, if the voltage applied to the USB power terminal 52 and the voltage applied to line 72 via the on-board power supply both remain above respective threshold levels, which in the illustrated case may both be about 4.5 Volts, the inputs to NOR gate 66 will both be low, causing the output line 68 to remain high. However, if the voltage applied at USB power terminal 52 is below the threshold voltage of component 56, the output 60 of component 56 will go low, which in turn causes the output of NOT gate 64 to go high, which in turn causes output 68 of NOR gate 66 to go low. Output 68 being in low state acts as a reset signal. For example, many microprocessors include a reset input that causes a reset operation responsive to the state of the input being at a low logic level.

In a similar manner, if the voltage applied at line 72 by the on-board power supply drops below the threshold voltage of component 70, the output 74 of component 70 will go low, which in turn causes the output of NOT gate 78 to go high, which in turn causes output 68 of NOR gate 66 to go low. Again, output 68 being in a low state acts a reset signal to the controller of the printer.

Referring again to FIG. 1, the USB host, in this case console 12, can reset the USB slave, in this case printer 14, by temporarily setting the voltage on the power line of the USB cable 26 low, which will responsively result in the low reset signal from the hardware reset circuit as described above. The USB host may determine to initiate the slave reset when communications with the USB slave fail, on the theory that processing in the USB slave has locked-up or otherwise failed, and the USB slave needs to be “rebooted.” In this regard, the control 16 of the USB host may include a USB communication monitor for detecting a processing failure state of the self-powered USB slave. For example, when the USB slave fails to respond or acknowledge a communication one or more times, the communication failure(s) may be interpreted as a processing failure of the USB slave. A reset control associated with the USB communication monitor responds to such a processing failure detection by temporarily setting the USB power line low as noted above.

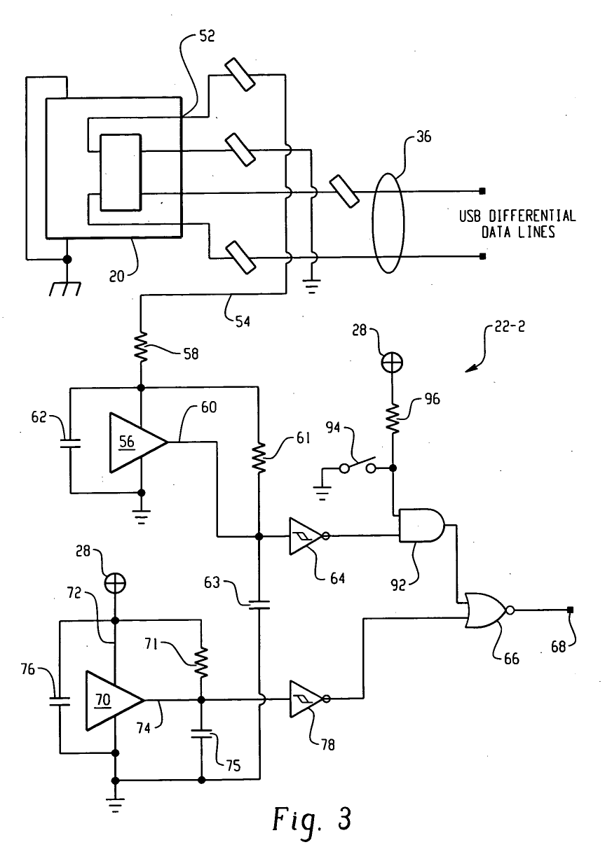

Referring now to FIG. 3, an alternative hardware reset circuit embodiment 22-2 is provided. Reset circuit 22-2 is similar in most respects to reset circuit 22-1 of FIG. 2 as reflected by the many common components, but reset circuit 22-2 includes an additional AND gate 92, switch 94, and resistor 96. As shown, the output of NOT gate 64 is connected as one input to AND gate 92, and the other input of AND gate 92 is connected through resistor 96 to the voltage established by the on-board power supply 28. The illustrated switch 94 is normally-open, with one side connected to ground and the other side connected to the low side of resistor 96. As long as switch 94 remains open, the output of AND gate 92 will be set according to the output of NOT gate 64. In particular, when the output of NOT gate 64 is low, the output of AND gate 92 will be low, and when the output of NOT gate 64 is high, the output of AND gate 64 will be high. It therefore follows that from an operational standpoint the reset circuit 22-2 will operate in the same manner as reset circuit 22-1, so long as switch 94 remains open. However, when switch 94 is closed, the associated input of AND gate 92 will be set low, meaning the output of AND gate 92 will always be low, regardless of the output of NOT gate 64. Thus, closure of the switch 94 effectively disables the USB power line based reset side of the reset circuit 22-2. This feature is recognized as useful in self-powered USB slave devices that have more than one communication port. For example, where the printer 14 (FIG. 1) also includes a serial communication port/connector 100, it would be important to disable the USB-power line based reset side of the reset circuit when the USB port/connector 20 is not used for communications, but instead the serial port/connector 100 is used. In such cases, the switch 94 could be automatically closed when a cable connector is connected to serial port 100. The switch 94 could be an electronic or mechanical-type switch.

It is to be clearly understood that the above description is intended by way of illustration and example only and is not intended to be taken by way of limitation. For example, while a printer is illustrated as a self-powered USB electronic device that includes the hardware reset circuit, it is recognized that the hardware reset circuit could be incorporated into a variety of other self-powered electronic devices that utilize USB communications. Exemplary of such other electronic devices are fax machines, copy machines, image scanners, output monitors, personal digital assistants (PDAs), digital cameras or even computer-controlled industrial equipment/machines that are controlled through a USB communication line. Likewise, while the USB host is illustrated as a console, it could take many other forms. While specific examples of hardware reset circuits are provided, variations are possible. For example, while the illustrated embodiments suggest that a reset characteristic on the power line of the USB interface port is a temporary drop in the voltage level, other types of reset characteristics could be established by the USB host on the USB power line, with the hardware reset circuit in the USB slave properly configured to detect and respond to the type of reset characteristic that is to be established. Other changes and modifications could be made.

1. An electronic device, comprising:
an electronic controller;
a USB interface port associated with the electronic controller for enabling communication with external devices;
a power source, independent of a power line of the USB interface port, for powering the electronic controller;
a hardware reset circuit operatively connected with the power line of the USB interface port, the hardware reset circuit connected to provide a reset input signal to the electronic controller when a reset characteristic of a signal on the power line of the USB interface port occurs.

2. The electronic device of claim 1 wherein the reset characteristic comprises voltage level on the power line of the USB interface port dropping below a threshold voltage level.

3. The device of claim 2 wherein the threshold voltage level is about 4.5 volts.

4. The device of claim 2 wherein the hardware reset circuit outputs a high logic level when the voltage level on the power line of the USB interface port is above the threshold level, and the reset input signal is a low logic level.

5. The device of claim 1 wherein the electronic controller includes a microprocessor that receives the reset input signal.

6. The device of claim 1 wherein the hardware reset circuit includes a first reset circuit portion associated with the power line of the USB interface port and a second reset circuit portion associated with the power source, the first reset circuit portion including an output with a reset state and a non-reset state and the second reset circuit including an output with a reset state and a non-reset state, wherein the hardware reset circuit produces the reset input signal when at least one of the first reset circuit portion output and the second reset circuit portion output is in its respective reset state.

7. The device of claim 6 wherein, when the power source is providing power, the output of the first reset circuit portion maintains its non-reset state in the absence of connection of a USB connector to the USB interface port.

8. The device of claim 1, wherein the device operates as one or more of a printer, a fax machine, a copy machine, an image scanner, a digital camera, an output monitor and a PDA.

9. A computerized machine connected with the device of claim 1 via a communication cable associated with the USB interface port of the electronic device, the machine operating as a USB host and the electronic device operating as a USB slave.

10. The device of claim 1, wherein the device comprises computer-controlled equipment or machinery.

11. In an electronic device including an electronic controller with a reset function, a USB interface port for communications and a power source independent of a power line of the USB interface port, a method of resetting comprising the steps of:
via a hardware circuit internal to the electronic device, monitoring power associated with the USB interface port power line;
upon detection of a threshold change in a signal associated with the USB interface power line, the hardware circuit outputs a reset signal to the electronic controller even when power supplied by the power source is normal.

12. The method of claim 11 wherein the change is detected as a change in voltage level.

13. The method of claim 12 wherein the change in voltage level is detected when voltage on the USB interface port power line falls below a threshold level.

14. In a computerized machine operating in communication with a self-powered USB slave device, the machine acting as a USB host and connected for communication with the self-powered USB slave device via a USB connection, a method of resetting the USB slave device comprising the step of:
the machine operates to temporarily establish a reset characteristic on a power line of the USB connection.

15. The method of claim 14 wherein the reset characteristic comprises temporarily causing a voltage level on the power line of the USB connection to drop below a set threshold.

16. The method of claim 14, further comprising:
prior to temporarily establishing the reset characteristic on the power line of the USB connection, the machine identifies a potential processing failure state of the self-powered USB slave device via attempted and failed communication with the self-powered USB slave device.

17. A computerized machine operable as a USB host for communication with a self-powered USB slave device, the computerized machine comprising:
a USB communication monitor for detecting a self-powered USB slave device processing failure state;
a reset control associated with the USB communication monitor for responding to detection of a self-powered USB slave device failure state by temporarily establishing a reset characteristic on a USB power line.

18. The computerized machine of claim 17 wherein the reset characteristic comprises temporarily causing a voltage level on the USB power line to drop below a set threshold.

19. The computerized machine of claim 16 wherein the USB communication monitor detects a self-powered USB slave device processing failure state based upon at least one communication error.

20. The computerized machine of claim 16 wherein the USB communication monitor detects a self-powered USB slave device processing failure state based upon repeated communication errors.

21. An electronic device, comprising:
an electronic controller;
a USB interface port associated with the electronic controller for enabling communication with external devices;
a power source, independent of a power line of the USB interface port, for powering the electronic controller;
a hardware reset circuit operatively connected to provide a reset input signal to the electronic controller, the hardware reset circuit operatively connected to be triggered via the power line of the USB interface port.

22. The device of claim 21 wherein the hardware reset circuit includes a first reset circuit portion associated with the power line of the USB interface port and a second reset circuit portion associated with the power source, the first reset circuit portion having an output for triggering the reset input signal and the second reset circuit portion having an output for triggering the reset input signal.

23. The device of claim 22 wherein the hardware reset circuit further includes a disabling circuit portion for preventing the first reset circuit portion from triggering the reset input signal in the absence of connection of a USB connector to the USB interface port.
